(19) United States
(12) Patent Application Publication
(10) Pub. No.: US 2019/0360235 A1
(43) Pub. Date: Nov. 28, 2019

(54) EASY INSTALL EXIT DEVICE

(71) Applicant: HAMPTON PRODUCTS INTERNATIONAL CORPORATION, Foothill Ranch, CA (US)

(72) Inventor: Jason L. Quinn, Spooner, WI (US)

(73) Assignee: HAMPTON PRODUCTS INTERNATIONAL CORPORATION, Foothill Ranch, CA (US)

(21) Appl. No.: 15/986,717

(22) Filed: May 22, 2018

(51) Int. Cl. E05B 9/08; E05B 65/10

(52) U.S. Cl. CPC E05B 9/08; E05B 65/1053

(57) ABSTRACT

A push bar exit device for installation on a door, wherein the exit device includes a head segment including a latch mechanism having a retractable latch bolt, the head segment being configured for installation on the door; a push bar segment including push bar operatively installed in a housing, the push bar segment being configured to be installable on the door adjacent to and separately from the head segment; and a coupling mechanism operatively coupling the push bar to the latch mechanism, whereby the latch mechanism is operable to retract the latch bolt in response to a pushing force applied to the push bar.

### CROSS-REFERENCE TO RELATED APPLICATION

Not applicable.

### FEDERALLY SPONSORED RESEARCH OR DEVELOPMENT

Not Applicable.

### BACKGROUND

The present disclosure generally relates to door opening mechanisms, and more particularly to a door exit device.

Door exit devices, sometimes referred to as panic devices or push bar devices, can be found on the interior side of doors to allow quick egress from a room or area. The user can quickly open the door by pushing against a push bar segment of the exit device. The exit device typically comprises a head segment and a push bar segment extending from the head segment. The push bar segment typically includes a longitudinal housing extending from the head segment, and a push bar mounted inside the longitudinal housing so as to be displaceable toward the interior of the housing. A pushing action against the push bar actuates a latch mechanism to withdraw a latch from a latch plate in the door jamb, thereby allowing the door to be opened in the direction of the pushing action. Once the pushing ceases, the push bar is biased back to its original by a spring mechanism in the housing, whereby the return of the push bar to its original position returns the latch to its latching position in which it can re-engage with the latch plate.

Although exit devices are simple to operate, installation onto an interior side of a door can be an arduous task. The difficulty comes from having to support a long push bar segment of the exit device against the door, while simultaneously aligning screws to prepared holes on the door, and then turning the screws with a screwdriver while still holding the push bar segment in position against the door.

### SUMMARY

The door exit device in accordance with this disclosure is configured to facilitate the installation of the exit device by separating the exit device into two or more subassemblies and breaking down the installation into a two-step process. In accordance with embodiments of this disclosure, the exit device can comprise a head segment and a push bar segment. The head segment can be fastened to the door independently of the push bar segment. That is, the head segment can be installed without having to support the added weight and bulkiness of the push bar segment. After the head segment is fastened to the door, the push bar segment of the exit device can be connected to the head segment and secured to the door.

In accordance with an embodiment of this disclosure, the head segment of the exit device can include a latch mechanism and a mounting bracket supporting the latch mechanism. The latch mechanism can comprise a latch bolt and a latch actuation apparatus operable to retract the latch bolt. The head segment can be aligned to a strike plate attached to a surface of a door jamb. After alignment with the strike plate, the head segment can be fixed to the inside surface of the door by conventional fasteners, such as screws. The latch mechanism may also be a subassembly installed on the door separately from the head segment.

After the head segment is secured to the door, the push bar segment can be assembled to the head segment. The push bar segment includes a housing containing a push bar that can be coupled directly or indirectly to the latch mechanism, whereby actuation of the push bar (i.e., by pushing it into the housing) causes the latch bolt to retract from the strike plate on the door jamb, so that the door can be opened. In one example, the push bar segment includes a slotted coupling arm that is maneuvered over an actuator pin of the latching mechanism, which is connected to the latch bolt. Pushing the push bar into the housing causes the coupling arm to pull the actuator pin of the latch mechanism, thereby causing the latch to retract toward the mounting bracket and away from the strike plate on the door jamb, thereby allowing the door to be opened.

In other embodiments, the latch mechanism can include a lever rotatably attached to the mounting bracket, with a first end of the lever engaging the push bar, and a second end of the lever engaging the latch bolt, which is also rotatably connected to the mounting bracket. Pushing the push bar into the housing pushes the first end of the lever, thereby causing the lever to rotate. As the lever rotates, the second end of the lever pushes on the latch bolt, which in turn causes the latch bolt to rotate and retract from the strike plate so that the door can be opened.

The aforementioned mechanisms for coupling the push bar to the latch bolt are exemplary only. Other coupling mechanisms will readily be accommodated by the subject matter of this disclosure.

After the push bar segment has been coupled to the latch mechanism, the push bar segment can be secured directly to the door and/or to the head segment. In one example, the push bar segment can be connected to the head segment by first engaging one or more resilient tabs on the push bar segment of the exit device in corresponding cutouts in the head segment. The push bar segment is then secured to the door. Other ways of connecting the push bar segment to the head segment can be accomplished by any conventional attachment means.

The head segment may also, instead, act as a coupler configured to couple the push bar segment to a separate latch mechanism previously secured to the door. The separate latch mechanism may be, for example, a mortise lock installed inside the edge of the door. A typical mortise lock comprises a drive with a specially shaped receiving hole configured to receive a similarly shaped spindle, and a latch bolt connected to the drive. The head segment is secured to the inside surface of the door with the spindle of the head segment inserted into the receiving hole to allow the drive to rotate with the spindle and retract the latch bolt. The push bar segment is secured to the head segment and/or the inside surface of the door, with the push bar coupled to the spindle of the head segment, such that depression of the push bar causes the latch bolt to retract.

### BRIEF DESCRIPTION OF THE DRAWINGS

FIG. 1 shows an embodiment of a door exit device comprising a head segment and a push bar segment in accordance with aspects of this disclosure.

FIG. 2 shows a partial exploded view of the exit device of FIG. 1.

FIG. 3 is an enlarged view of the portion encompassed within the circle 3 in FIG. 2.

FIG. 4 is a close-up view of the connection between the head segment and the push bar segment of the exit device of FIG. 1.

FIG. 5 is a view of an exit device in accordance with this disclosure installed on a door mounted in a door frame including a door jamb.

### DETAILED DESCRIPTION

The detailed description set forth below in connection with the appended drawings is intended as a description of the presently preferred embodiments of a door exit device in accordance with aspects of the presently-disclosed components, assemblies, and method. It is not intended to represent the only forms in which the present components, assemblies, and method may be constructed or utilized. The description sets forth the features and the steps for constructing and using the embodiments of the present components, assemblies, and method in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

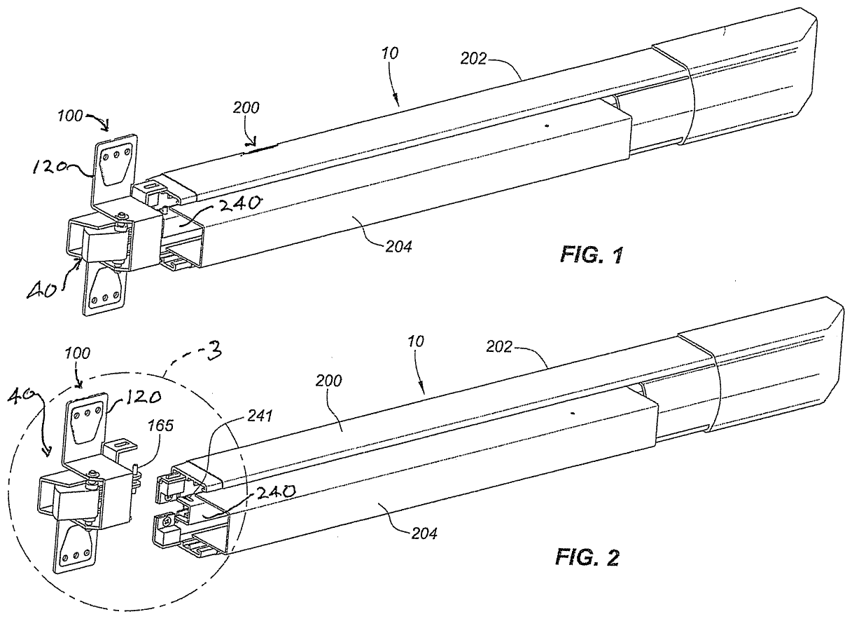

FIGS. 1 and 2 illustrate one embodiment of an exit device 10 for a door 20 (FIG. 5). The exit device 10 comprises a head segment 100, and a push bar segment 200 connected directly or indirectly to the head segment 100. The head segment 100 and the push bar segment 200 are two separate assemblies configured to be separately installed on the door 20. For example, the head segment 100 may be installed on the door first, after which the push bar segment 200 may be operatively coupled to the head segment 100 and secured to the door 20. To this end, the head segment 100 includes a mounting bracket 120 that can accommodate conventional fasteners (such as screws, not shown), while the push bar segment 200 may be secured to the door by means of fasteners in the interior of a push bar housing 202.

The push bar housing 202 accommodates a push bar 204 that is configured to be pushed toward the interior of the housing 202 to actuate a latch mechanism 40 in the head segment 100. A spring mechanism (not shown) in the housing 202 biases the push bar 204 to a return position after it has been pushed, as is well-known in the art. The push bar housing 202 is configured to be mounted horizontally on a door, and it has a coupling end (shown in the drawings) that is configured to be located relative to the latch mechanism 40 in the head segment 100 for operative coupling therewith, as will be described below.

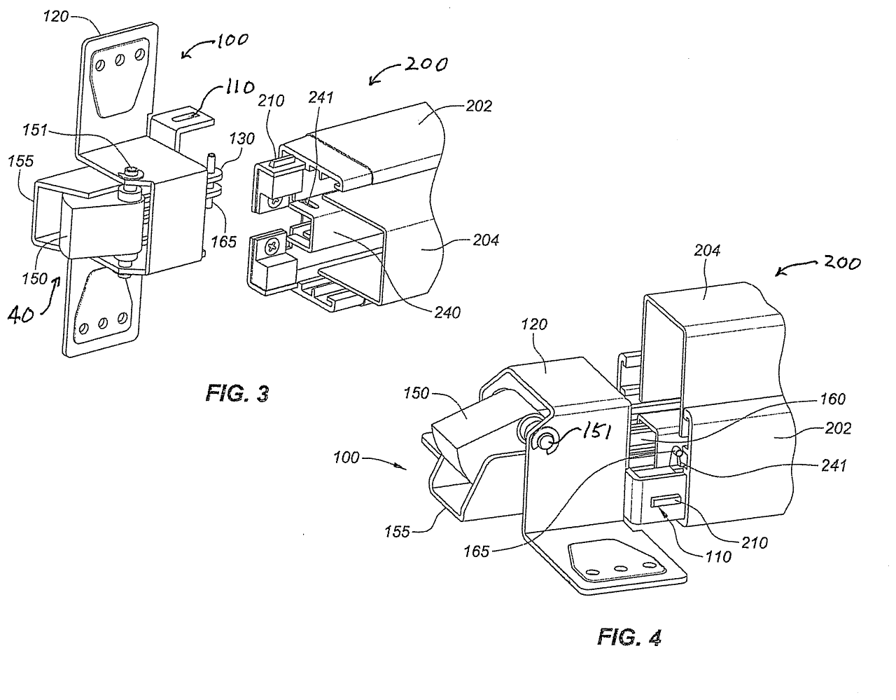

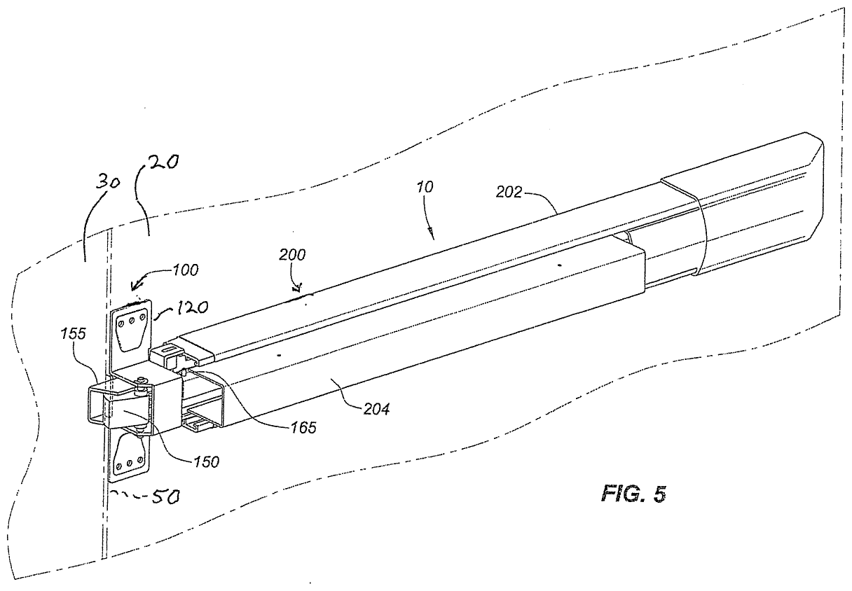

In the illustrated embodiment, the push bar 204 is operatively coupled to the latch mechanism 40 by an actuator pin 165 in the latch mechanism 40 that is configured to be received in a slot 241 near the end of a coupling arm 240 in the housing 202 that is engaged by the push bar 204, as will be described below. Other mechanisms for operatively coupling the push bar 204 to the latch mechanism 40 may readily suggest themselves. The push bar segment 200 may also be directly attachable to the head segment 100 to properly align and maintain a link between the push bar segment 200 and the head segment 100. For example, as shown in FIGS. 3 and 4, the push bar segment 200 can be attached to the head segment 100 by snapping resilient tabs 210, located at the coupling end of the push bar housing 202, into corresponding apertures or cutouts 110 in the head segment 100. Other ways of attaching the push bar segment 200 to the head segment 100 are contemplated and are readily accommodated. Once the connection between the push bar 204 and the latch mechanism 40 is made, actuation of the push bar 204 by a pushing action toward the interior of the housing 202 retracts a spring-loaded latch of the latch mechanism 40, so that the door can be opened, as discussed below.

Referring to FIGS. 3 and 4, the latch mechanism may include a latch bolt 150 pivotably connected to the mounting bracket 120 by a spring-loaded pivot pin 151, which, in turn, is operatively connected to the actuator pin 165. The latch actuation mechanism may also include a dead latch 155 operatively coupled to the actuator pin 165 so as to be slidable within the mounting bracket 120 to retract the latch bolt 150. Thus, when the push bar 204 is pushed toward the interior of the housing 202, the actuator pin 165 is pulled toward the housing 202, thereby causing the latch bolt 150 to retract by rotation about the pivot pin 151. Other latch retracting means may be accommodated within the scope of this disclosure, such as retracting the latch bolt 150 by translation, rather than by pivoting. The dead latch 155 may also be retracted inward (i.e., toward the housing) when the latch bolt 150 is retracted, if not already pushed inward by a strike plate (not shown) on a door jamb 30 (FIG. 5) when the door is in the closed position. If the dead latch 155 has not been retracted or actuated, the latch bolt 150 can be manually depressed. When the dead latch 155 is retracted, the latch bolt 150 cannot be manually depressed. This prevents someone from using a shim (such as a credit card, for example) to force the latch bolt 150 into an actuated “door open position.” Other mechanisms or ways to prevent the latch bolt 150 from being depressed when the dead latch 155 is actuated may be used.

After the head segment 100 is installed on the door, the coupling arm 240 can be manipulated to maneuver the slot 241 over the actuator pin 165, to connect the head segment 100 and the push bar segment 200, and to provide an operative coupling between the push bar 204 and the latch mechanism 40. The operative coupling transfers a pushing force applied to the push bar 204 through the coupling arm 240 and the actuator pin 165 to the latch bolt 150, so as to retract the latch bolt 150 from a recess in a strike plate 50 mounted on the door jamb 30, as shown in FIG. 5. Specifically, when the push bar 204 is depressed or pushed into the push bar housing 202, the push bar 204 engages the coupling arm 240 so as to pull the actuator pin 165, thereby causing the latch bolt 150 to retract. The push bar 204 can be directly connected to the coupling arm 240, or it can be connected indirectly by an intermediate member (e.g., a lever, not shown), such that movement of the push bar 204 into the push bar housing 202 causes the coupling arm 240 to move in a direction approximately orthogonal to the movement of the push bar 204. Other means to couple the push bar 204 to the latch mechanism may suggest themselves as suitable for particular applications.

Although exemplary embodiments of the exit devices, their components, and related methods have been specifically described and illustrated herein, many modifications and variations will be apparent to those skilled in the art. Furthermore, it is understood and contemplated that features specifically discussed for one exit device embodiment may be adapted for inclusion with another exit device, provided the functions are compatible. Accordingly, it is to be understood that exit devices, components, and related methods constructed according to the subject matter disclosed herein may be embodied other than as specifically described herein.

1. A push bar exit device for installation on an exit door, the push bar exit device comprising:
a head segment configured for installation on an exit door, the head segment including a latch mechanism having a retractable latch bolt;
a push bar segment including a push bar operatively installed in a housing, the push bar segment being configured to be installable on the exit door adjacent to and separately from the head segment; and
a coupling mechanism operatively coupling the push bar to the latch mechanism when the head segment and the push bar segment are installed on the exit door, whereby the latch mechanism is operated to retract the retractable latch bolt in response to a pushing force applied to the push bar.

2. The push bar exit device of claim 1, wherein the head segment includes a pair of slots, and wherein the push bar housing has a coupling end with a pair of resilient tabs, each of which is configured to be received in one of the slots to connect the head segment to the push bar segment.

3. The push bar exit device of claim 1, wherein the push bar is operatively coupled to the latch bolt by an actuator pin.

4. The push bar exit device of claim 3, wherein the actuator pin is coupled to a coupling arm disposed in the housing so as to be engageable by the push bar, whereby a pushing force applied to the push bar is transferred to the latch bolt by the coupling arm and the actuator pin so as to retract the latch bolt.

5. A method of installing a push bar exit device on a door, comprising:
providing a head segment including a latch mechanism having a retractable latch bolt;
installing the head segment on a door;
providing a push bar segment including a push bar operatively installed in a housing;
operatively coupling the push bar to the latch mechanism, so that the latch bolt is retracted in response to a pushing force applied to the push bar; and
installing the push bar segment on the door adjacent to the head segment.

6. The method of claim 5, wherein the step of installing the push bar segment includes attaching the housing of the push bar segment to the head segment.

7. The method of claim 5, wherein the step of operatively coupling comprises:
providing a coupling arm in the housing in a position to be engageable by the push bar; and
connecting an end of the coupling arm to an actuation pin in the latch mechanism that is operatively coupled to the latch bolt;
whereby the latch bolt is retractable in response to a pushing force applied to the push bar.

8. The method of claim 6, wherein the step of attaching includes snapping a pair of resilient tabs at an end of the housing into corresponding apertures in the head segment.
